(19) United States
(12) Patent Application Publication
(10) Pub. No.: US 2008/0087767 A1
(43) Pub. Date: Apr. 17, 2008

(54) Overhead food and beverage transport and serving device

(76) Inventor: Frank M. Scott, Breckenridge, CO (US)

Correspondence Address: FRANK M. SCOTT, PO BOX 3715, Breckenridge, CO, 80424, US

(21) Appl. No.: 11/724,674

(22) Filed: Mar. 16, 2007

Related U.S. Application Data
(60) Provisional application No. 60/852,117, filed on Oct. 17, 2006.

(51) Int. Cl. B64D 11/04

(52) U.S. Cl. 244/118.6

(57) ABSTRACT

Method and system for transporting, serving and collecting beverages and meals to passengers of large transports such as airplanes and trains. A foldable, retractable, extendable, lowering, stowable, sliding, lockable device mounted overhead the passengers on a rail or track. It facilitates the mass delivery, serving and collection of passenger meals and beverages in a safe and efficient manner.

### THE FIELD OF THE INVENTION

The present invention relates generally to aircraft, aircraft passenger and crew/passenger safety in addition to increasing efficiency of crew operations in the delivery of food and beverages.

### BACKGROUND OF THE INVENTION

There is major safety and efficiency related problems with the current wheeled food and beverage dispensing cart used on airliners.

The passenger's movement along the aisle is restricted at any time the cart is being used or moved through the aisle.

The cart must be secured quickly during any turbulence.

The cart has the ability to injure passengers and crew during aircraft maneuvering or turbulence. The crew must repeatedly bend down to retrieve meals from the cart.

The cart is not easily heated, cooled or insulated.

The cart is heavy.

To give emergency or urgent assistance to a passenger at short notice the flight attendant must leave the cart unattended in the aisle relying only on gravity and its wheel brake to secure it.

A solution to all these problems is obtained in the invention claimed herein.

### BRIEF SUMMARY OF THE INVENTION

The system utilizes an overhead carriage mounted on one of two rail/track options. This carriage can move along the aircraft aisle above passengers utilizing currently unused space. The carriage has a single hinge that allows a concave pivoting section to lower down to the flight attendant, inside this pivoting section are meals, snacks or beverages which the flight attendant can easily dispense. At any time the pivoting section can be easily and quickly raised to permit the movement of passengers or to secure the meals and beverages during turbulence. When this pivoting section is closed the meals are stored at a tilted angle, the angle is dependant on the size and application of the system design. A larger unit will store more meals at an angle closer to horizontal. When the pivoting section is lowered to the serving position the meal trays are horizontal, ready to be served to passengers.

The system incorporates a dead man brake, three user positions afforded by detents in the main hinge/pivot, a spill skirt, a serving tray, a simple opening lanyard/draw cord, an up position lock and a spring bias to the full up position.

This invention improves passenger safety—it cannot strike a seated passenger during turbulence like current food carts.

### IMPROVEMENT OVER PREVIOUS ART

This system improves upon the previous art referenced in expired Patent 3999630 McPhee:

It provides a safe, watertight and secure enclosure for food and beverages.

It has a dead man brake.

It has a single pivot hinge connecting the carriage to the pivoting section.

It provides a serving/preparation platform, a spillage skirt and a fluid collection bilge.

It provides an up-biased spring within the hinge, an up-position lock and a simple cord release mechanism for this lock.

It has three detents providing three user angles, of which only the lowest position releases the brake.

The secure mode for aircraft turbulence and maneuvering is fully up and closed

The food is stored on trays at fixed angles to the pivoting section.

The system can be insulated to keep food hot or beverages cool.

It can be rapidly closed, locked and secured in any location in the aisle or galley.

The system can range in size to suit the application.

It can be left unattended if urgent passenger assistance is required elsewhere.

In extreme turbulence it can self close if the lower detent is overcome.

It provides a secure handle to flight attendants in the open position during aircraft turbulence and maneuvering.

It can be used during a wider range aircraft maneuvering without food falling off the side of the pivoting section or spilling due to the concave edges and integral spillage skirt.

Use of an attached garbage bag during post meal pick-up permits immediate clearing of food trays and separation of garbage from reusable or unused items.

### DETAILED DESCRIPTION OF THE INVENTION

This system is locked in place on the rails unless the flight attendant applies an appropriate downwards force to release the brake. If the flight attendant releases this downwards force the system will lock—similar to a dead mans brake.

The pivoting section hinge contains an up biased spring loading. This avoids the inadvertent dropping of the pivoting section should the closed position locking mechanism fail. It also allows flight attendants to lower the pivoting section safely and assist them closing this section too. In the event of severe turbulence the up-biased spring loading will be able to close the pivoting section to the up and locked position under it owns momentum. A lower position detent on the hinge will overcome the up spring bias when the pivoting section is lowered below an appropriate angle—depending on device size and application.

To lower the system a draw cord is used. This draw cord allows shorter flight attendants to reach the system while the aforementioned spring bias permits safe lowering of the pivoting section to the serving and moving positions. The use of a draw cord minimizes injuries that a hard lever could cause.

The draw cord would also activate the up and locked position latch or locking mechanism. If inadvertently operated the draw cord would not lower the pivoting section as the up-biased spring loading would hold the pivoting section in place—to lower the pivoting section would require concerted effort on the draw cord.

The meals would be stored on the pivoting section at an angle that minimized leaking of any liquids/juices from meals. The angle to which the pivoting section is lowered to is aircraft application dependant. The meals would sit horizontal when the pivoting section was lowered to the serving position. As the pivoting section is raised to the closed position the tray upon which the meals sit would remain fixed with respect to their mounted angle on the pivoting section and the meals would therefore also tilt from the horizontal position to an angle greater and horizontal but not exceeding 60 degrees.

A fluid drainage groove/spillage skirt runs would line the outer and lower rim of the pivoting section to capture and channel any liquid to a sump/bilge in the lower portion of the pivoting section. This would reduce the difficulty flight attendants currently have dispensing liquids during turbulence. These fluids are stored in an integral lower bilge for later cleaning if required.

The pivoting section would curve up on the edges in a concave manner to assist in food tray/drink security and prevent lateral food tray movement, this would also be integral to the spillage skirt. When closed this bathtub design would be able to secure extensive liquid spillage.

Other options to prevent lateral food tray movement when opened to the serving position would be through use of raised edges on each food tray or a cord running the length of the pivoting section on either side of the food trays.

The extreme lower end of the pivoting section would be a level serving and food preparation platform. This section could also mount a garbage bag underneath it to instantly separate food and other garbage from the trays as they are collected—a process currently not able to be completed on an airline wheeled cart.

A lifting flap or sliding flap in this platform would allow direct access to the top of the garbage bag through the base of the food preparation platform. This would allow for access to a large garbage bag at all phases of food/beverage delivery and collection without reducing space for food, beverages and utensils.

The level preparation area would house the handle used to move the system along the aisle.

When in the serving position the system is locked on the rails/tracks, the range of movement from the level, locked serving position to the lower moving position would be slight and dependant on aircraft and pivoting section size. The intention is to allow the preparation area to hold open beverages whilst the flight attendant moves the system along the aisle. The minor downwards force would release the brake and permit device travel without tilting so far down as to allow beverages to slide off the tray.

The food supporting trays house the airline meals, snacks or beverages. These supporting trays remain with the pivoting section and should not be confused with the trays given to the passenger. The supporting trays hold the passengers food tray. The supporting trays are held at a fixed angle so that they are horizontal when the pivoting section is lowered to the serving position. Upon delivery of the passenger meal of drink the supporting trays could be slid down an integral set of side rails to stack all trays at the lower end of the pivoting section. This requirement would be application dependant and would require two side rails running the length of the pivoting section and housing the small hinges of the food support trays. The trays could be held in place by a gravity lock or detent which would require the supporting tray to be lifted in order to slide it down to the lower end of the pivoting section.

The size and strength of the main pivot/hinge would minimize lateral movement—resulting in very little travel of the lower pivoting section sideways (towards the left and right side of the aisle). Much less lateral movement than current food carts.

If required a rubber seal on the pivoting section would reduce odor/aroma escaping from the stored meals.

One possible configuration includes power supplied to the invention through the rails to allow for an oven heating element. This would allow meals to be cooked overhead and free up valuable galley space current taken up by ovens.

Another variation of the design includes all design parameters claimed but mounts the pivoting section offset from the center aisle overhead the passenger baggage compartments. This variation allows all the same benefits of the center aisle design but utilizes the frame structure already in place above passenger luggage compartments in many aircraft. This variation would lower at an angle to the center aisle with a curved or angle arm to avoid passenger's heads. This variation is particularly suited to smaller domestic aircraft designed to serve beverages and snacks only. FOG 10 highlights this design.

If cooling was required the invention could be stored in a suitable position to engage ducting from the aircraft's air conditioning to keep beverages cool without requiring addition aircraft power.

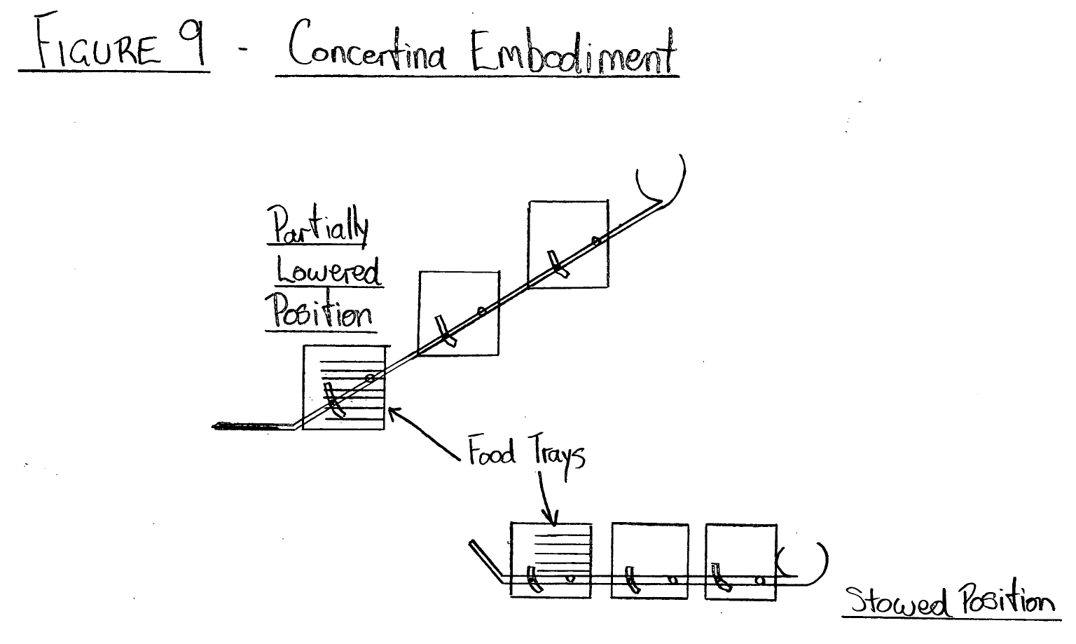

Another embodiment of the invention shown in FIG. 9 shows a variation of the design to be adapted to a non-tilted/concertina tray design allowing meals or beverages to be stored horizontally. In this embodiment the food trays are grouped inside several boxes that remain in a horizontal position via the use of spring loading and guides/tracks. In this design the chance of spillage is reduced but the ability to contain spilt fluids is also reduced. This embodiment maintains all the other advantages described above.

### DESCRIPTION OF THE DRAWINGS

### Brief Description of the Drawings

The various features and advantages of this invention will become apparent to those skilled in the art from the following detailed description of the currently preferred embodiment. The drawings that accompany the detailed description can be briefly described as follows:

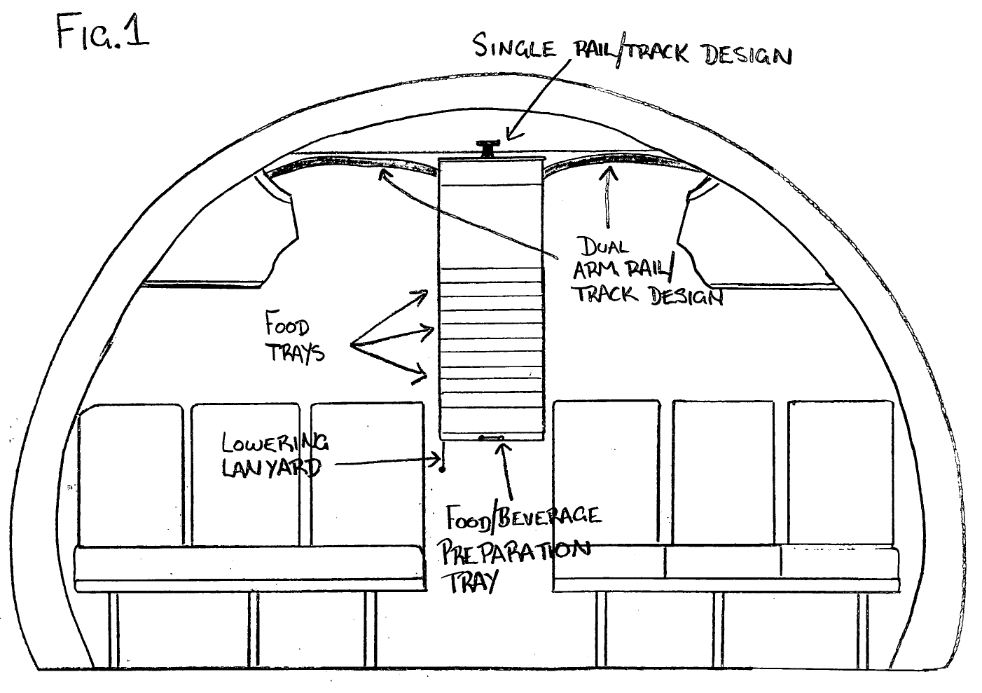

FIG. 1 shows an aircraft cut away with the pivoting section open and both possible rail/track options.

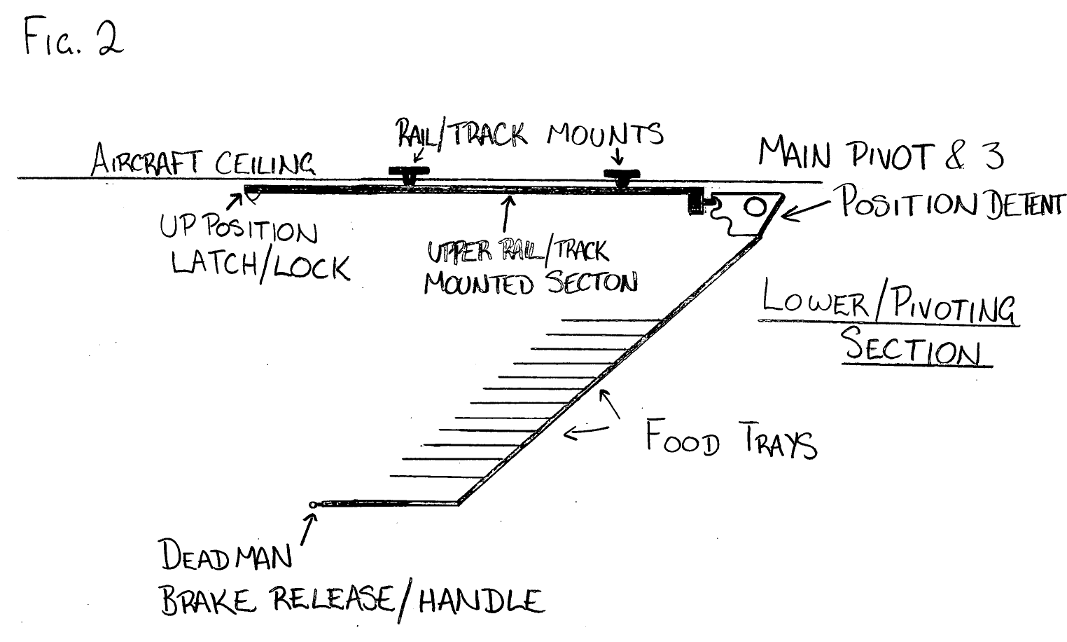

FIG. 2 shows invention side view in lower serving position.

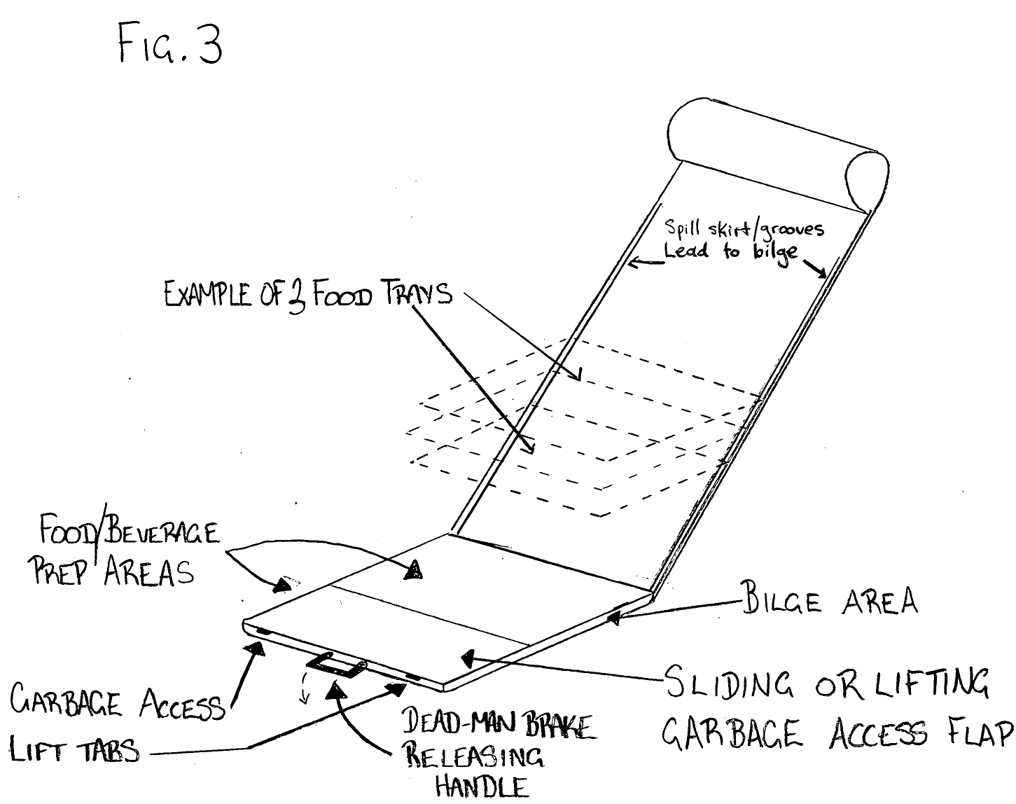

FIG. 3 shows one embodiment of the lower swivel section of the invention including some food tray drawings.

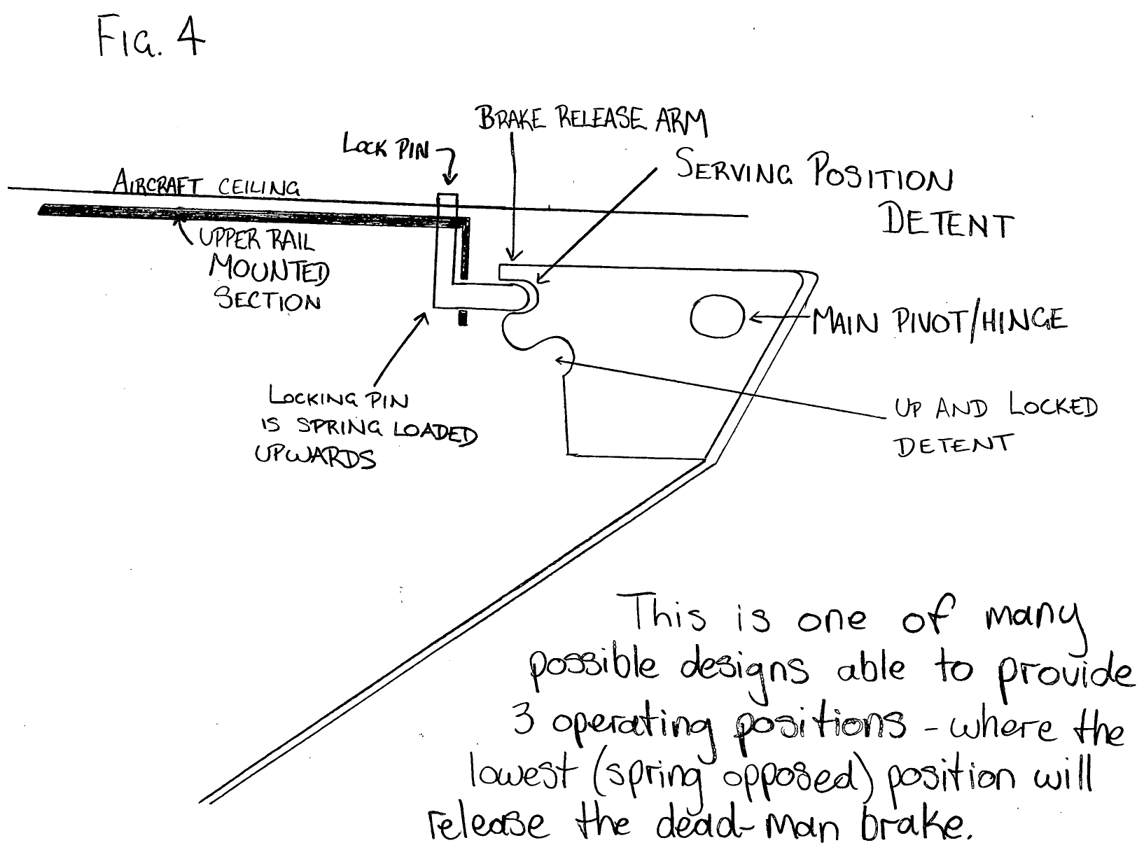

FIG. 4 shows one possible embodiment of the pivoting section's 3 position swivel detent.

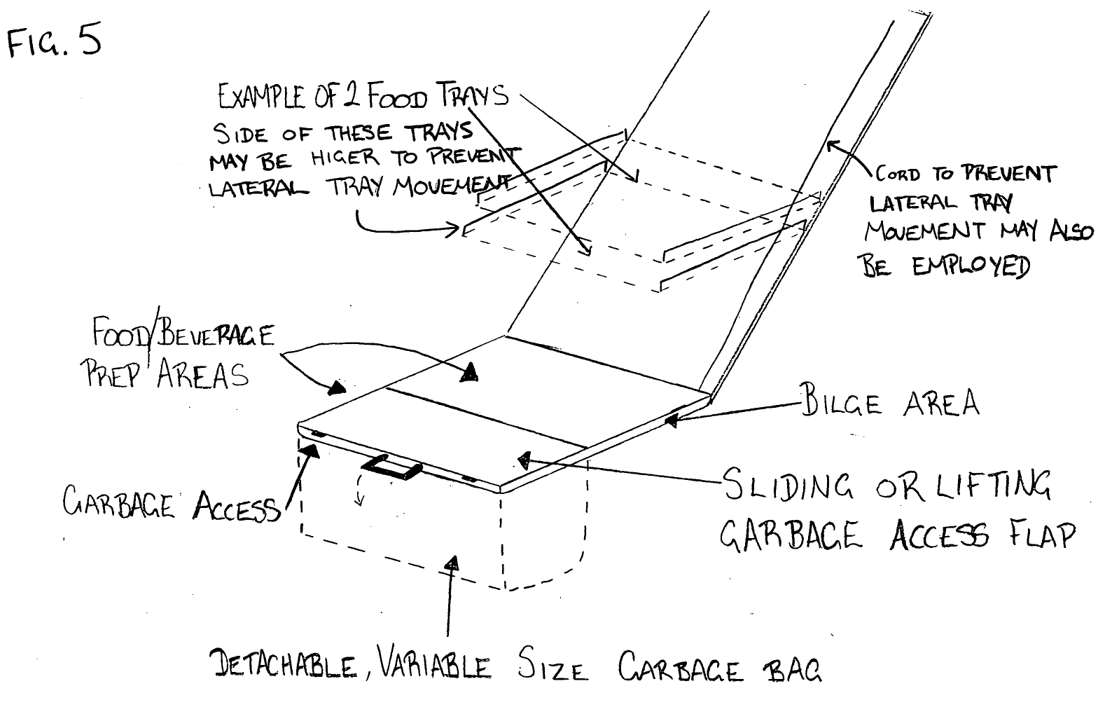

FIG. 5 shows the lower preparation tray, one embodiment of a detachable garbage bag and bilge area

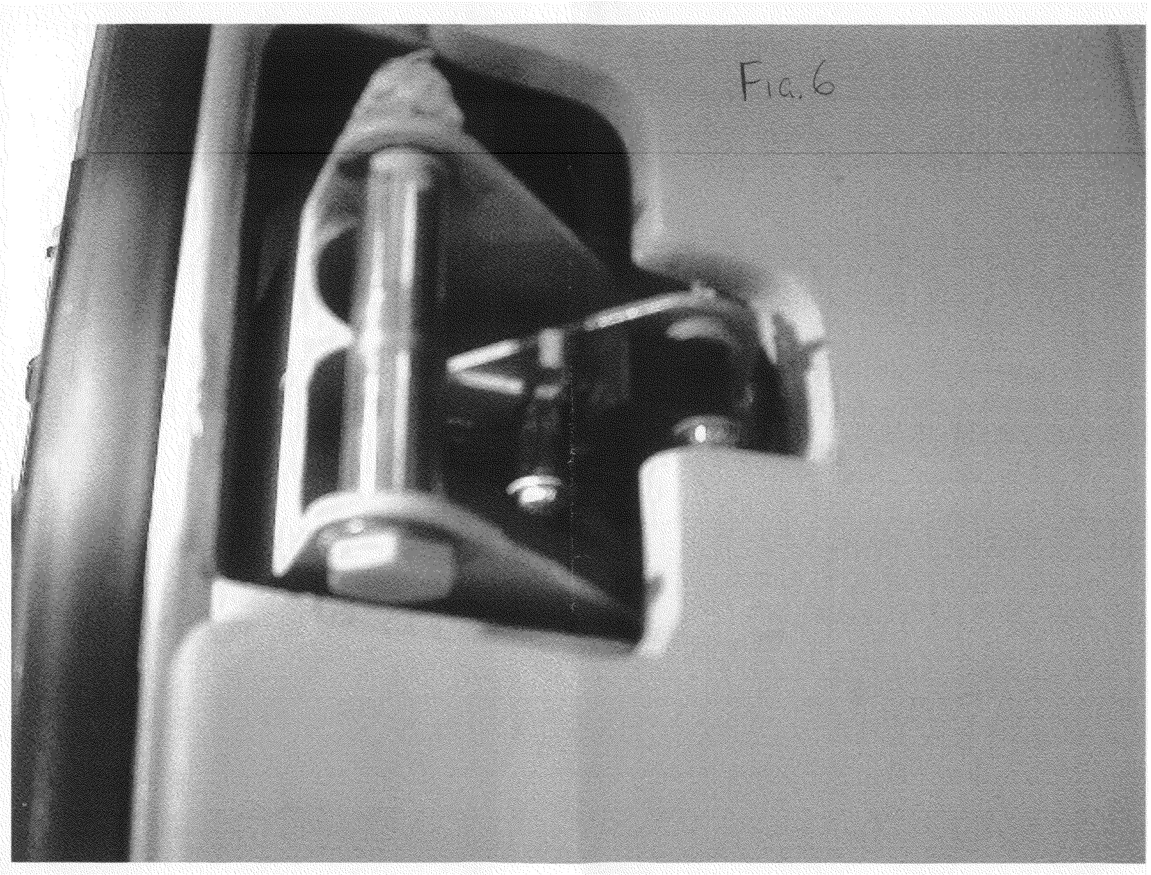

FIG. 6 shows one embodiment of an upper lock and release lanyard

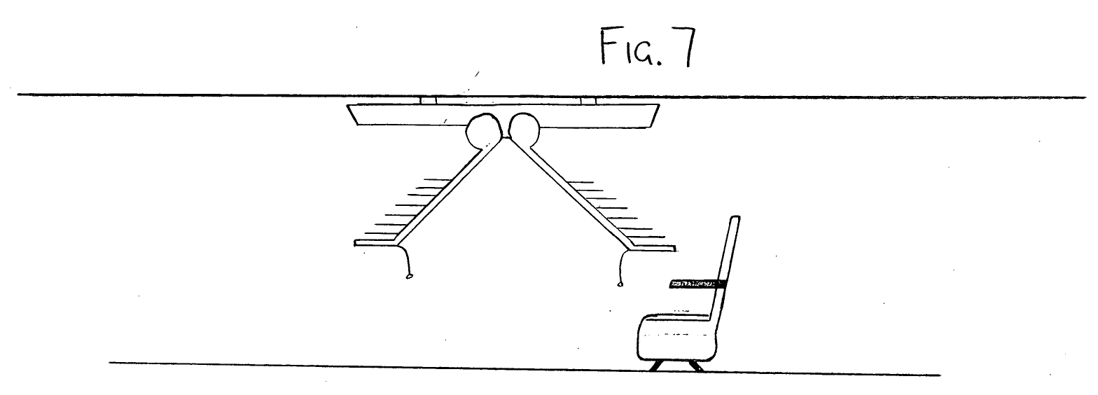

FIG. 7 shows a possible double-sided design embodiment

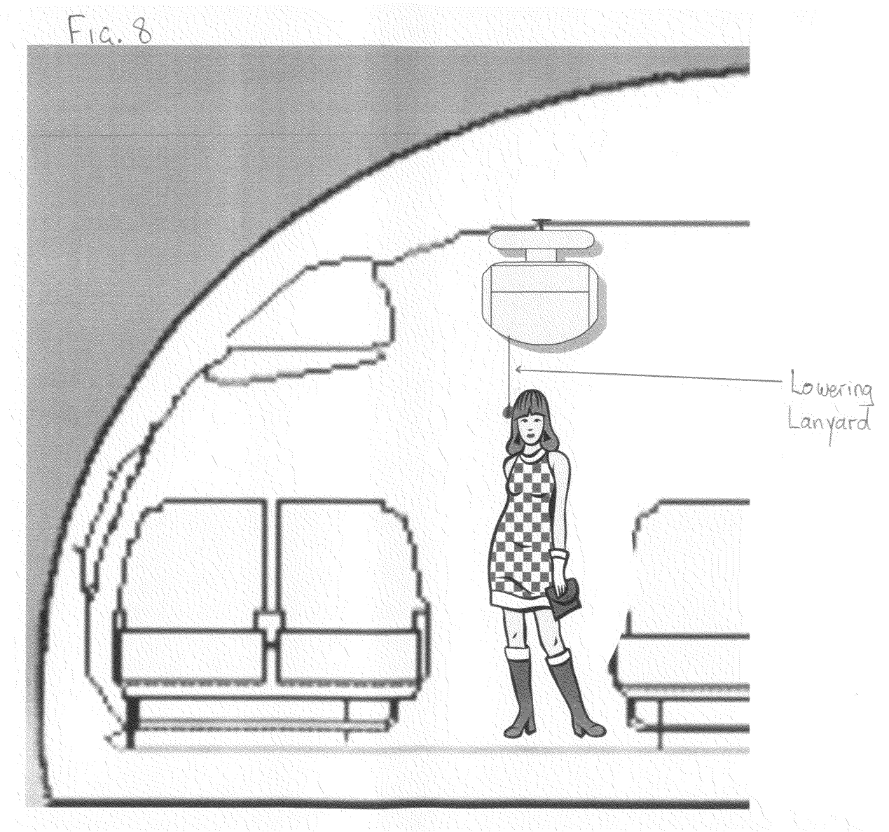

FIG. 8 shows an artists impression of one version of the invention in the stowed position.

FIG. 9 shows a variation on the tray stowage from a tilted to a pivoting/concertina design

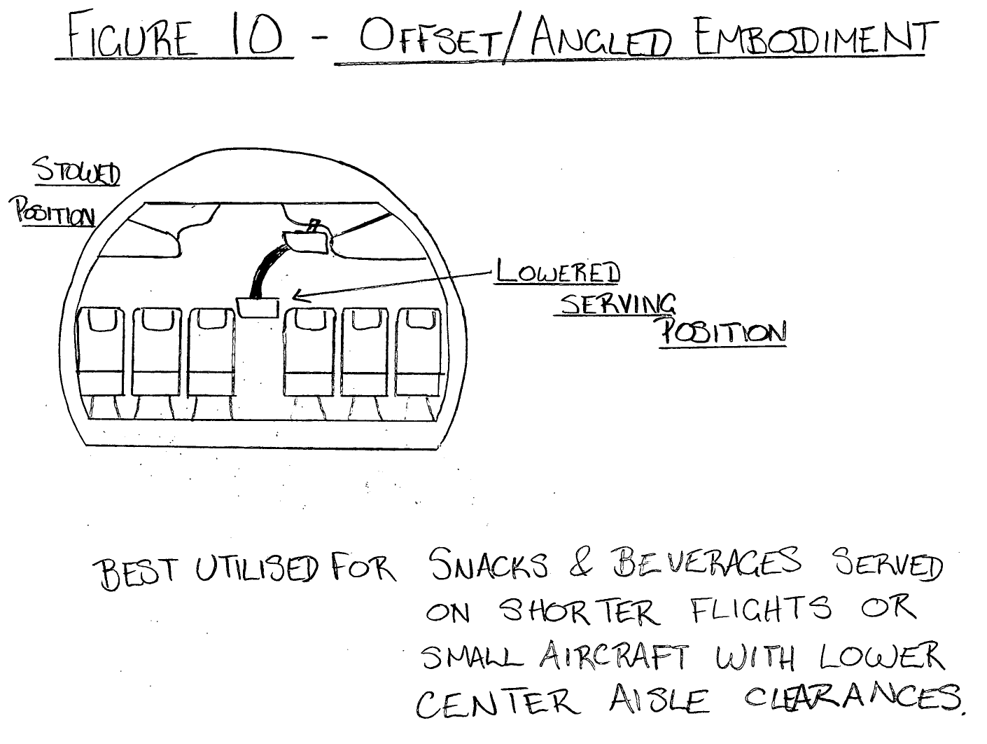

FIG. 10 shows the offset variation utilizing support rails above passenger cargo stowage compartments with an angles lowering design.

I claim:

1. An overhead food and beverage transport and serving device comprising, in combination:
a. an overhead movable carriage system supported by overhead rails/tracks
b. a pivoting section connected to the carriage system which lowers down from a single hinge at variable angles from the overhead rail mounted carriage
c. a braking system to lock the entire device in place at any point along the overhead rail/track
d. angled food trays or platforms attached to the pivoting section from which prepared meals and/or beverages could be accessed, stored and served
e. a lower tray platform to prepare meals and beverages
f. a garbage bag attachment suspended from the lower section of the pivoting arm
g. detents within the pivoting section's hinge to bias the pivoting section position at either an appropriate open serving angle or an up and closed angle
h. a fluid spillage groove around the sides and lower edges of the pivoting section to collect spilled fluids and liquids
i. a cleanable bilge to store any spilled fluids or liquids
j. a sliding or flip-open panel in the lower tray food preparation platform to access a garbage bag

2. A longitudinally orientated, horizontal aircraft overhead rail or track combination optimized to transport the system in claim 1 utilizing either a single overhead aisle track or rail, or tracks located either side and above the aircraft overhead passenger stowage area.

3. A braking device that locks the carriage in place when the pivoting section is lowered towards the serving position or any position between fully closed and this serving position. This brake remains on and active unless the pivot is fully opened/lowered to the transporting position which is slightly lower than the serving position detent and spring opposed.

4. A swivel detent system at the intersection of the carriage and the pivoting section affording lowering of the pivoting section in claim 1 to be opened to three positions:
a. a suitable serving angle detent where it will remain unless acted upon vertically up or down with the appropriate force, in this position the carriage is locked in place by the brake as in claim 3,
b. fully up and closed detent position to hold the pivoting section closed unless acted upon vertically with appropriate force,
c. a full down detent position which releases the brake in claim 3, this position is spring loaded to return to the position in claim 4a so if pressure is released by the operator at any time the carriage will lock in place and the pivoting section will return to the serving angle as per claim 4a.

5. A swivel detent system that releases the locking/braking device in claim 3 when the operator applies appropriate downwards force to the pivoting section to locate it into the detent described in claim 4c.

6. A locking mechanism to lock the lower end of the pivoting section to the non-swivel end of the carriage when the system is fully up and closed.

7. A releasing/lowering cord permitting operators to unlock the locking mechanism described in claim 6 and assist operators to reach and lower the pivoting section.

8. A spring bias orientated in the vertically up direction that will assist the operators to close the pivoting section, resist gravitational opening of the pivoting section when fully closed, assist the operator to lower the pivoting section slowly/safely using the device described in claim 7, and assist automatic closing and locking of the pivoting section in severe turbulence.

9. A post-mix or regular beverage serving stowage utilizing space in the carriage and the pivoting section for dispensing of beverages.

10. A method to prevent lateral food tray movement utilizing either a curved up, concave design to the outer edges of the pivoting section, a cord running either side of the devices pivoting section adjacent to the food trays or raised lips on the sides of each food tray.

11. A watertight seal and a fluid and liquid drainage groove/spillage skirt running the length of the pivoting section.

12. A cleanable sump/bilge located on the lower end of the pivoting section in the lower tray food preparation platform to collect fluids and liquids from the drainage groove described in claim 11.

13. Integral food support trays held at fixed angles to the pivoting section to store and support airline food and beverages.

14. A swiveling food tray design that keeps trays horizontal by use of guides to swivel boxes of trays as the pivoting section is lowered.
